(19) United States
(12) Patent Application Publication
(10) Pub. No.: US 2018/0335951 A1
(43) Pub. Date: Nov. 22, 2018

(54) INFORMATION PROCESSING APPARATUS, NON-TRANSITORY COMPUTER-READABLE STORAGE MEDIUM, AND INFORMATION PROCESSING METHOD

(71) Applicant: FUJITSU LIMITED, Kawasaki-shi (JP)

(72) Inventor: Yoshihiro Ohba, Numazu (JP)

(73) Assignee: FUJITSU LIMITED, Kawasaki-shi (JP)

(21) Appl. No.: 15/974,849

(22) Filed: May 9, 2018

(30) Foreign Application Priority Data
May 16, 2017 (JP) 2017-097464

(51) Int. Cl. G06F 3/06

(52) U.S. Cl. CPC G06F 3/0608; G11B 2020/1238; G06F 3/0689; G06F 3/0631

(57) ABSTRACT

An information processing apparatus including a processor configured to execute a process including receiving a first allocation request to allocate first data to any one of a plurality of disk storage devices, the first allocation request including a designation of an allocation unit for the first data, allocating the first data to a first disk storage device, receiving a second allocation request to allocate second data, the second allocation request including a designation of an allocation unit for the second data, and allocating the second data to the first disk storage device when the designation of the allocation unit for the second data is same as the designation of the allocation unit for the first data and allocating the second data to a second disk storage device when the allocation unit for the second data is different from the allocation unit for the first data.

### CROSS-REFERENCE TO RELATED APPLICATION

This application is based upon and claims the benefit of priority of the prior Japanese Patent Application No. 2017-97464, filed on May 16, 2017, the entire contents of which are incorporated herein by reference.

### FIELD

The embodiments discussed herein are related to an information processing apparatus, a non-transitory computer-readable storage medium, and an information processing method.

### BACKGROUND

An information processing apparatus such as a computer stores data in a storage device. The storage device memorizes the data. For example, as the storage device, there is a disk device. The disk device (disk storage device) incorporates a magnetic disk, and writes and reads data to and from the magnetic disk.

For example, in a case where a data set is created on a direct access volume, a system for managing the data set by a start address and an end address of an area called as an extent that is physically and continuously allocated as the data set on the volume, is proposed. In this proposal, in a case where there are consecutive areas that can be handled on a cylinder unit within the extent that is originally defined as allocation on a track unit, the system treats the area as allocated to the cylinder unit instead of the track unit. With this, an extent termination confirmation process for each track boundary decreases.

In addition, there is also a proposal of a space search program in which a management table for managing a file allocation area on 1 MB unit and on 4 KB unit in the file allocation area of the disk device is stored in the disk device, and used for searching for the amount of an empty space according to a requested file capacity. In this proposal, the space search program efficiently searches (the number of entries to be searched is small) by using the management table of a large management unit of the former for a large empty space search. On the other hand, the space search program efficiently uses the storage area by using the management table of a small management unit of the latter for small capacity empty space search.

Japanese Laid-open Patent Publication No. 63-307525 and Japanese Laid-open Patent Publication No. 5-46447 are examples of the related art.

### SUMMARY

According to an aspect of the invention, an information processing apparatus including a memory, and a processor coupled to the memory and the processor configured to execute a process, the process including receiving a first allocation request to allocate first data to any one of a plurality of disk storage devices, the first allocation request including a designation of an allocation unit for the first data, the allocation unit for the first data being a cylinder unit or a track unit, allocating the first data to a first disk storage device in the plurality of disk storage devices, receiving a second allocation request to allocate second data to any one of the plurality of disk storage devices, the second allocation request including a designation of an allocation unit for the second data, the allocation unit for the second data being the cylinder unit or the track unit, and allocating the second data to the first disk storage device when the designation of the allocation unit for the second data is same as the designation of the allocation unit for the first data and allocating the second data to a second disk storage device in the plurality of disk storage devices when the allocation unit for the second data is different from the allocation unit for the first data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an information processing apparatus of a first embodiment;

FIG. 2 is a diagram illustrating a hardware example of a mainframe of the second embodiment;

FIG. 3 is a diagram illustrating a structure example of an HDD;

FIG. 4 is a diagram illustrating example of fragmentation of an unused space in an HDD;

FIG. 5 is a diagram illustrating a functional example of the mainframe.

FIG. 6 is a diagram illustrating a classification example of track allocation and cylinder allocation;

FIG. 7 is a diagram illustrating an example of a management table;

FIG. 8 is a flowchart illustrating an example of space allocation;

FIG. 9 is a diagram illustrating a first specification example of the space allocation;

FIG. 10 is a diagram illustrating a second specification example of the space allocation;

FIG. 11 is a diagram illustrating a change from a mixed volume to an undetermined volume;

FIG. 12 is a diagram illustrating a change from the mixed volume to a cylinder allocated volume;

FIG. 13 is a diagram illustrating a change from the mixed volume to a track allocation volume; and

FIG. 14 is a diagram illustrating an example of a consecutive unused space.

### DESCRIPTION OF EMBODIMENTS

As described above, in a disk device, as a storage area allocation unit for data, a cylinder unit and a track unit may be used. In this case, there is a problem that fragmentation of an unused storage area in the disk device tends to occur easily when allocation on the cylinder unit and allocation of the track unit are performed in a mixed manner on the same disk device.

In one aspect, it is an object to alleviate mixing of cylinder allocation data and track allocation data on the same disk device.

Hereinafter, this embodiment will be described with reference to the drawings.

### First Embodiment

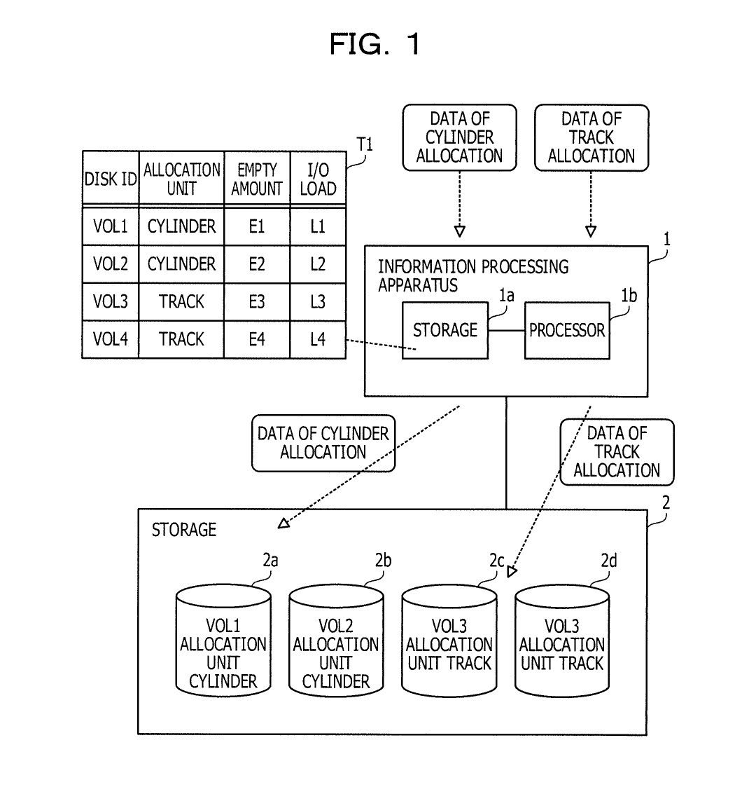

FIG. 1 is a diagram illustrating an information processing apparatus of a first embodiment. An information processing apparatus 1 is connected to a storage 2. The storage 2 includes a plurality of the disk devices. The disk device incorporates a magnetic disk, and writes and reads data to and from the magnetic disk. The disk device may be called as a magnetic disk device, a hard disk drive (HDD), or the like. The information processing apparatus 1 controls writing of the data to the disk device and reading of the data from the disk device.

The information processing apparatus 1 manages the storage area allocation for the data. A storage area allocation unit includes a cylinder unit in the disk device or a track unit in the disk device. Which unit to use is specified by a user as the storage area allocation unit for the data. For example, when inputting a request of the storage area allocation for the data to the information processing apparatus 1, the user designates the cylinder unit or the track unit as an allocation unit. The information processing apparatus 1 provides a function of making efficiently the storage area of each disk device by managing the allocation unit for each disk device. The information processing apparatus 1 includes a storage la and a processor 1b.

The storage 1a may be a volatile storage device such as a random access memory (RAM), and may be a non-volatile storage device such as an HDD and a flash memory. The processor 1b may include a central processing unit (CPU), a digital signal processor (DSP), an application specific integrated circuit (ASIC), a field programmable gate array (FPGA), or the like. The processor 1b may be a processor for executing a program. The “processor” may also include a set of processors (multiprocessor).

The storage la stores information on the storage area allocation unit for the data for each disk device. For example, the plurality of the disk devices included in the storage 2 include the disk devices 2a, 2b, 2c, and 2d. The identification information (disk ID (IDentifier)) of the disk device 2a is “VOL1”. The disk ID of the disk device 2b is “VOL2”. The disk ID of the disk device 2c is “VOL3”. The disk ID of the disk device 2d is “VOL4”.

For example, the storage la stores a management table T1 as information of the storage area allocation unit for the data. The management table T1 is management information for managing the allocation unit, an empty amount in the disk device of the disk ID, and input and output (I/O) loads of the disk device for disk ID.

The processor 1b classifies the allocation unit of a first disk device into the cylinder unit, classifies the allocation unit of the second disk device into the track unit, and sets the classified result in information (management table T1) stored in the storage 1a.

For example, the processor 1b searches for disk devices that is not classified as either the cylinder unit and the track unit, and classifies the searched disk device as the allocation unit designated by the request of the allocation at a timing at which a request of the storage area allocation is received by the user. Then, the processor 1b registers the classified result in association with the disk ID of the disk device in the management table T1.

As an example, the processor 1b classifies the disk device 2a, 2b, 2c, and 2d as follows. The processor 1b classifies the allocation unit of the disk device 2a into the cylinder unit, and sets the classified result in the management table T1. The processor 1b classifies the allocation unit of the disk device 2b into the cylinder unit, and sets the classified result in the management table T1. In this case, the disk device 2a is an example of the first disk device. The disk device 2b is an example of the first disk device. The processor 1b classifies the allocation unit of the disk device 2c into the track unit, and sets the classified result in the management table T1. The processor 1b classifies the allocation unit of the disk device 2d into the track unit, and sets the classified result in the management table T1. In this case, the disk device 2c is an example of the second disk device. The disk device 2d is an example of the second disk device. In addition, the processor 1b monitors the empty amount and the I/O load of each disk device, and registers the monitored result in the management table T1.

The processor 1b allocates first data (cylinder allocation data) in which the storage area allocation of the cylinder unit is designated, based on information (management table T1) stored in the storage la in the first disk device. For example, the processor 1b allocates the first data in the disk device 2a. At this time, the processor 1b may select the disk device of an allocation destination according to the empty amount and the I/O load of the disk devices 2a and 2b of which the allocation unit is classified into the cylinder unit. More specifically, the processor 1b can secure the empty amount of a size designated by the request of the allocation of a user among the disk devices 2a and 2b and may determine the disk device with the lowest I/O load as the allocation destination.

In addition, the processor 1b allocates second data (track allocation data) designated by the storage area allocation of the track unit in the second disk device, based on the information (management table T1) stored in the storage 1a. For example, the processor 1b allocates the second data in the disk device 2c. At this time, the processor 1b may select the disk device of the allocation destination according to the empty amount and the I/O load of the disk devices 2c and 2d of which the allocation unit is classified as the track unit. More specifically, the processor 1b can secure the empty amount of a size designated by the request of the allocation of a user among the disk devices 2c and 2d, and may determine the disk device with the lowest I/O load as the allocation destination.

In this manner, the processor 1b allocates the storage area of the disk device of which the allocation unit is classified as the cylinder unit, for the designation of the cylinder unit. In addition, the processor 1b allocates the storage area of the disk device of which the allocation unit is classified as the track unit for the designation of the track unit.

However, as the storage area allocation unit for the data, in a case where the cylinder unit and the track unit are used, the allocation of the cylinder unit and the allocation of the track unit may be mixedly performed on the same disk device. For example, this is a case where the user is requested to designate the disk device of the allocation destination together with the storage area allocation. Usually, the user often designates the disk device of the allocation destination without recognizing the storage area allocation unit for each disk device. Therefore, the cylinder allocation data and the track allocation data are likely to be mixed on the same disk device.

However, mixing of the cylinder allocation data and the track allocation data on the same disk device becomes a factor of fragmentation of an unused space in the disk device. When there are a plurality of the unused spaces are divided by fragmentation, it becomes difficult to secure the unused space of a requested size as a continuous area. Therefore, when there are a lot of the fragmented unused spaces, the efficiency of the storage area allocation for the data decreases. For example, for requests of relatively large size such as cylinder allocation, there is a possibility that the storage area of the disk device may not be sufficiently used without allocating the fragmented unused space.

Therefore, the processor 1b classifies a part (for example, disk devices 2a and 2b) of the plurality of the disk devices with the cylinder unit, and classifies the other (for example, disk devices 2c and 2d) with the track unit, and registers the classified result in the management table T1. Then, the processor 1b refers to the management table T1 to designate the allocation unit in the request of the allocation accepted thereafter, and selects the disk device corresponding to the classification as the allocation destination.

With this, the cylinder allocation data is stored in the disk device of which the allocation unit is classified as a cylinder. In addition, the track allocation data is stored in the disk device of which the allocation unit is classified as a track. Therefore, it is possible to decrease the mixing of the cylinder allocation data and the track allocation data on the same disk device. In addition, at this time, acceptance of designation of the disk device in the allocation destination by the user may not be desirable. That is, the user does not have to individually designate the disk devices.

Furthermore, by decreasing the mixing of the cylinder allocation data and the track allocation data on the same disk device, the fragmentation of the unused space on the disk device is suppressed. Therefore, a possibility that the unused space of the desired size can be secured as a continuous area increases, and the efficiency of the storage area allocation for the data can be improved. That is, the storage area of each disk device can be efficiently used.

Data to be a target of the storage area allocation may be a unit called as a data set or a unit called as a file. For example, the data set is the substance of a data record stored in the disk device. In addition, for example, the file is a set of data sets referred to in a process of a predetermined program (one group of logical data). One file may correspond to one data set.

In addition, in the above example, the disk device 2a, 2b, 2c, and 2d are incorporated in an external storage 2 for the information processing apparatus 1, but the disk device 2a, 2b, 2c, and 2d may be incorporated in the information processing apparatus 1.

### Second Embodiment

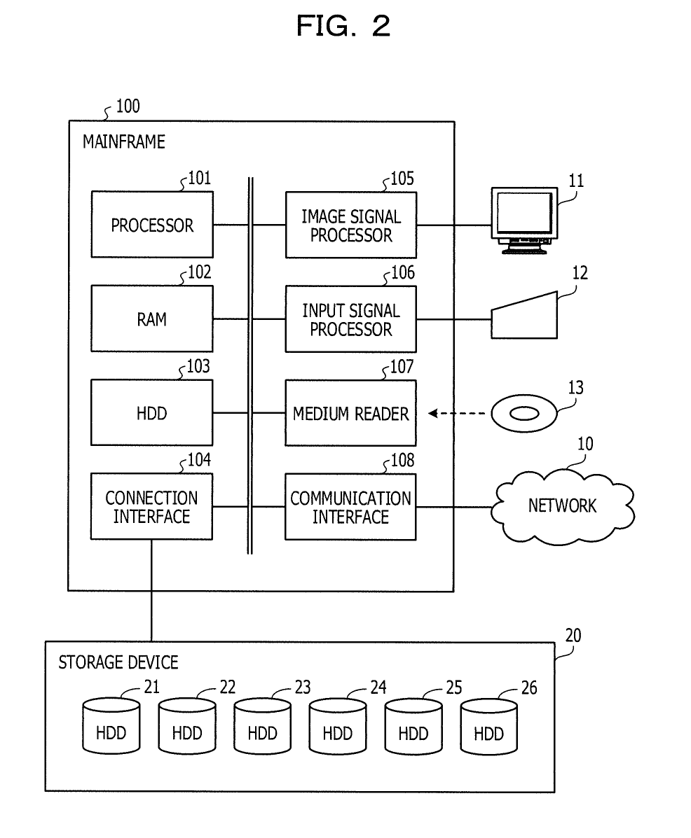

FIG. 2 is a diagram illustrating a hardware example of a mainframe of the second embodiment. The mainframe 100 is a computer of performing a user's business process. The mainframe 100 includes a processor 101, a RAM 102, a HDD 103, a connection interface 104, an image signal processor 105, an input signal processor 106, a medium reader 107, and a communication interface 108. Each hardware is connected to a bus of the mainframe 100.

The processor 101 is hardware of controlling an information process of the mainframe 100. The processor 101 may be a multiprocessor. For example, the processor 101 is the CPU, the DSP, the ASIC, the FPGA, or the like. The processor 101 may be implemented by combining components equal to or greater than two of the CPU, the DSP, the ASIC, the FPGA, and the like.

The RAM 102 is a main storage device of the mainframe 100. The RAM 102 temporally stores a part of an operating system (OS) and an application program executed in the processor 101. In addition, the RAM 102 stores various types of data used in the process by the processor 101.

The HDD 103 is an auxiliary storage device of the mainframe 100. The HDD 103 magnetically writes and reads data to and from the incorporated magnetic disk. The HDD 103 stores the program of OS, the application program, and the various types of data. The mainframe 100 may include another type storage device such as the flash memory and a solid-state drive (SSD), and may include a plurality of the auxiliary storage device.

The connection interface 104 is an interface for connection with the storage device 20. As the connection interface 104, it is possible to use FCLINK (registered trademark), a fibre channel (FC), or the like. In addition to the storage device 20, other peripheral devices such as a drive device that writes and reads data to and from a magnetic tape medium can be connected.

The image signal processor 105 outputs an image to a display 11 connected to the mainframe 100 according to a command from the processor 101. As the display 11, a cathode ray tube (CRT) display, a liquid crystal display, or the like can be used.

The input signal processor 106 acquires an input signal from an input device 12 connected to the mainframe 100, and outputs the acquired signal to the processor 101. For example, as the input device 12, a pointing device such as a mouse or a touch panel and a keyboard can be used.

The medium reader 107 is a device for reading a program and data stored in the recording medium 13. For example, as the recording medium 13, a magnetic disk such as a flexible disk (FD) and a HDD, an optical disk such as a compact disk (CD) and a digital versatile disc (DVD), or a magneto-optical disk (MO) can be used. In addition, for example, as the recording medium 13, a non-volatile semiconductor memory such as a flash memory card can also be used. For example, the medium reader 107 stores a program and data read from the recording medium 13 in the RAM 102 or the HDD 103 according to a command from the processor 101.

The communication interface 108 performs communication other devices through a network 10. The communication interface 108 may be a wired communication interface or a wireless communication interface.

Here, the storage device 20 includes a plurality of HDDs. The HDD is an example of the disk device. Each of the plurality of HDDs is used for storing a file handled in a business process of the mainframe 100. The plurality of HDDs include HDDs 21, 22, 23, 24, 25, and 26.

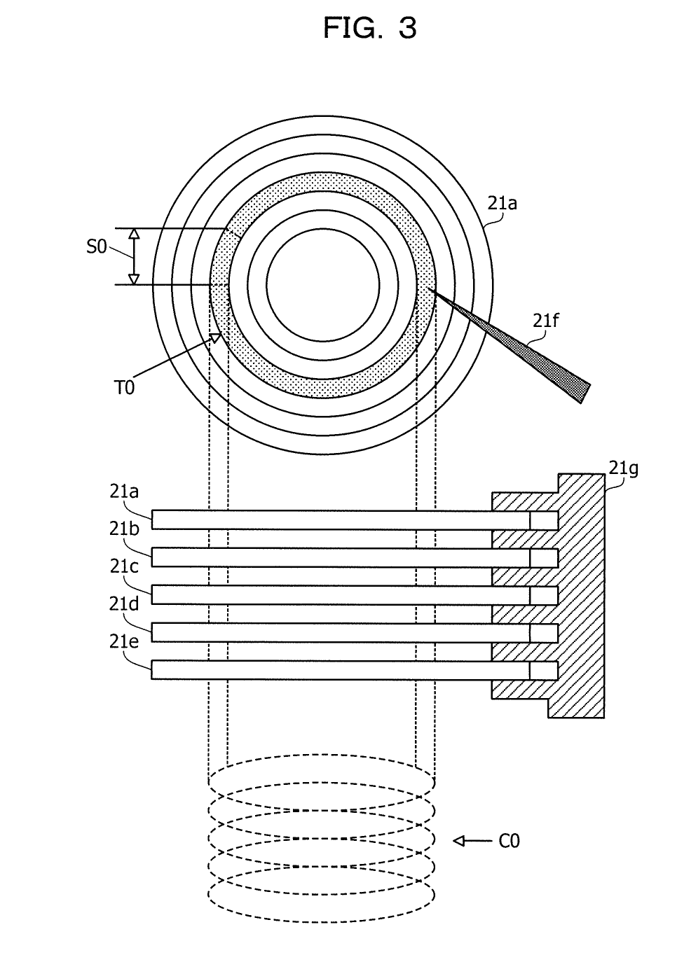

FIG. 3 is a diagram illustrating a structure example of the HDD. The HDD 21 includes platters 21a, 21b, 21c, 21d, and 21e, a magnetic head 21f, and an actuator 21g. The platters 21a, 21b, 21c, 21d, and 21e are metal disks (magnetic disk) on which magnetic material is coated or deposited, and holds data on a magnetic recording layer on a surface formed of the magnetic material. The center axes of the platters 21a, 21b, 21c, 21d, and 21e are arranged on the same axis (rotation axis by spindle motor (not illustrated)).

The magnetic head 21f includes a swing arm, and writes and reads data to and from a magnetic recording layer on a surface of the platter in a head part of an end portion of the swing arm. The magnetic head 21f is provided for each of the platters 21a, 21b, 21c, 21d, and 21e (HDD 21 includes a plurality of magnetic heads).

The actuator 21g is a positioning device which supports the magnetic head 21f and moves the magnetic head 21f in the radial direction of the platter. A unit of the physical storage area of the HDD is divided into the track T0, a sector S0, and a cylinder C0. The track T0 is a concentric storage area on a surface of the platter 21a. The track T0 is one of a plurality of tracks on the platter 21a. The sector S0 is an area in which the track T0 is divided with a unit of a predetermined size. The sector S0 is one of a plurality of sectors on the track T0. The cylinder C0 is a set of tracks of the same radius on surfaces of the platters 21a, 21b, 21c, 21d, and 21e.

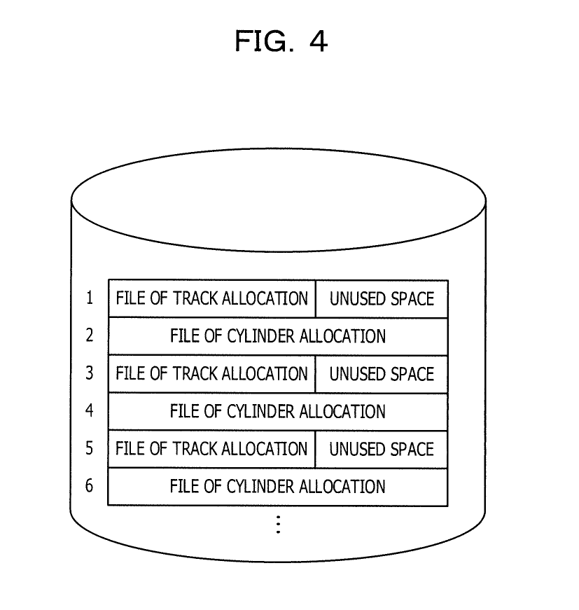

HDDs 22, 23, 24, 25, and 26 also have the same structure as the HDD 21. The HDD is sometimes called as a volume. FIG. 4 is a diagram illustrating an example of the fragmentation of the unused space in the HDD. In the FIG. 4, the storage area of the cylinder unit is associated with one row in the HDD and numbers (“1”, “2”, “3”, “4”, “5”, and “6”) indicating the cylinders are attached to the left side of the storage area of the cylinder unit.

Here, in the operation of the mainframe 100, the storage area allocation unit for the file is designated by the user. As the allocation unit, there are the cylinder unit and the track unit. Performing the storage area allocation with the allocation unit as the cylinder unit is called as cylinder allocation. Performing the storage area allocation with the allocation unit as the track unit is called as track allocation. In addition, a file to which the storage area is allocated in the cylinder unit is referred to as a cylinder allocation file. A file to which the storage area is allocated in the track unit is referred to as the track allocation.

In an example of FIG. 4, the track allocation file is stored in a cylinder of the cylinder number “1”. An unallocated storage area of the cylinders with the cylinder number “1” is the unused space. Here, the “space” indicates the storage area.

The cylinder allocation file is stored in the cylinder with the cylinder number “2”. The track allocation file is stored in the cylinder with the cylinder number “3”. The unallocated storage area of the cylinders of the cylinder number “3” is the unused space.

The cylinder allocation file is stored in the cylinder with the cylinder number “4”. The track allocation file is stored in the cylinder with the cylinder number “5”. The unallocated storage area of the cylinder with the cylinder number “5” is the unused space.

The cylinder allocation file is stored in the cylinder with the cylinder number “6”. For example, one cylinder includes 15 tracks. Therefore, when the track unit allocation is performed at 500 tracks (TRK), a gap of 5 tracks which is not a cylinder boundary is formed in the final cylinder. In addition, for the cylinder allocation file, the storage area allocation is performed from a cylinder boundary. Therefore, when the cylinder allocation is performed after performance of the track unit allocation, the unused space for 5 tracks in the final cylinder remains without using. Therefore, for example, when a combination of the track allocation (allocation which can implement gap of 5 tracks) and the cylinder allocation is repeated three times, a total of 15 tracks of the unused space which are not contiguous may be produced.

As described above, when the cylinder allocation file and the track allocation file present on one HDD by mixing them, the unused space is likely to be divided by shredding. The plurality of the divided unused spaces may not be allocated as the continuous area. Therefore, for example, when the cylinder allocation is requested, even when the total size of each unused space of the entire HDD satisfies the requested size, the size of each unused space may not be the requested size. In this case, the cylinder allocation to a corresponding HDD may not be performed.

As described above, the mixing of the cylinder allocation file and the track allocation file causes the fragmentation of the storage area of the HDD, and becomes a factor of deteriorating utilization efficiency. Therefore, the mainframe 100 provides a function of reducing the mixture of the cylinder allocation file and the track allocation file and improving the utilization efficiency of the storage area of the HDD.

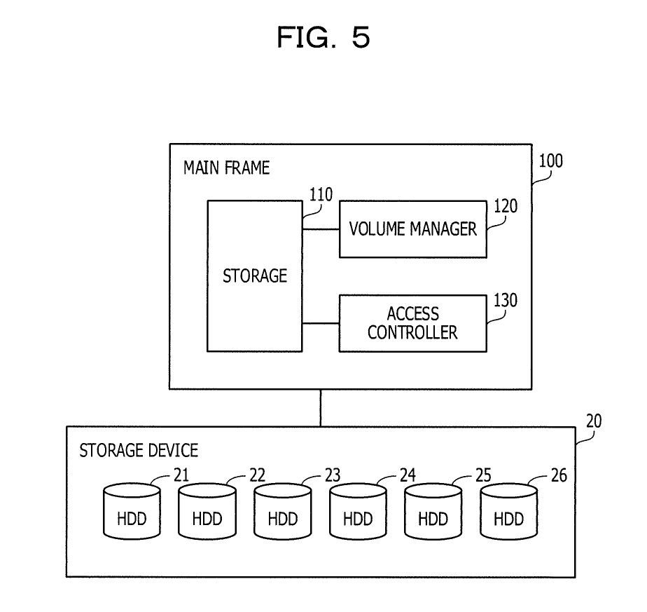

FIG. 5 is a diagram illustrating a functional example of the main group. The mainframe 100 includes a storage 110, a volume manager 120, and an access controller 130. The storage 110 is realized by using the storage area of the RAM 102 and the HDD 103. In addition, the volume manager 120 and the access controller 130 are realized by the processor 101. For example, the processor 101 exhibits the functions of the volume manager 120 and the access controller 130 by executing a program stored in the RAM 102. However, the volume manager 120 and the access controller 130 may be realized by a hard-wired logic such as the FPGA and the ASIC.

The storage 110 stores the management information for managing the storage area allocation unit on each of the HDDs 21, 22, 23, 24, 25, and 26. The management information includes empty amount information of the HDD and information of the I/O load in addition to the allocation unit.

The volume manager 120 manages an empty amount and the I/O load for each HDD. The volume manager 120 acquires periodically the empty amount and the I/O load for each HDD from the storage device 20 or when the access controller 130 operates. The volume manager 120 updates the management information stored in the storage 110 by the empty amount and the I/O load which are acquired.

The volume manager 120 may perform initialization of the HDD and deletion of the all files stored in the HDD. In a case where the initialization of the HDD and the deletion of the all files stored in the HDD are performed, the volume manager 120 sets the allocation unit of the HDD in the management information stored in the storage 110 to be undetermined.

The access controller 130 controls access to write and read files to and from each of the HDDs 21, 22, 23, 24, 25, and 26. The access control by the access controller 130 is performed according to a command input by a user. For example, the user inputs a predetermined command (request of allocation command) requesting the storage area allocation for the file to the mainframe 100 by using a job control language (JCL). The request command of the allocation includes designation (referred to as requested space amount) of the allocation unit and size of the storage area to be allocated.

Particularly, with the request command of the allocation, it is possible to designate an allocation destination device (here, HDD) or a device group. However, the access controller 130 may not receive individual designation of the allocation destination device. That is, the access controller 130 may receive the designation of a device group including the HDDs 21, 22, 23, 24, 25, and 26. As described above, the request command of the allocation not including the designation of a specific device may be referred to as a “request command of unspecified allocation” or simply an “unspecified allocation request”.

The access controller 130 determines the storage area allocation unit for each HDD in accordance with the access control. Specifically, the access controller 130 preferentially selects the HDD in which the allocation unit is not determined, over the HDD in which the allocation unit is determined for the unspecified allocation request. Then, the access controller 130 allocates the storage area of the allocation unit in which the unspecified allocation request is designated for the selected HDD. Then, the access controller 130 classifies the allocation unit of the HDD into the allocation unit designated by the unspecified allocation request. The access controller 130 registers the classified result (determined allocation unit) for the HDD in the management information stored in the storage 110.

In addition, in a case where the allocation unit of the entire HDDs is determined, the access controller 130 performs the storage area allocation for the file without performing the above classification for the inputs of the unspecified allocation request by the user. Specifically, the access controller 130 selects the HDD included in the allocation unit designated in the unspecified allocation request as the allocation destination by referring the management information stored in the storage 110. The access controller 130 writes a corresponding file in the storage area of the HDD of the allocation destination. At this time, in a case where there are a plurality of candidate HDDs to be allocated, the access controller 130 narrows down the allocation destinations based on the empty amount and the I/O load of each candidate registered in the management information.

Furthermore, in a case where the empty amount requested by the unspecified allocation request may not be secured from the HDD included in the allocation unit designated in the unspecified allocation request, the access controller 130 allows the HDDs included in a different allocation unit to be the allocation destination.

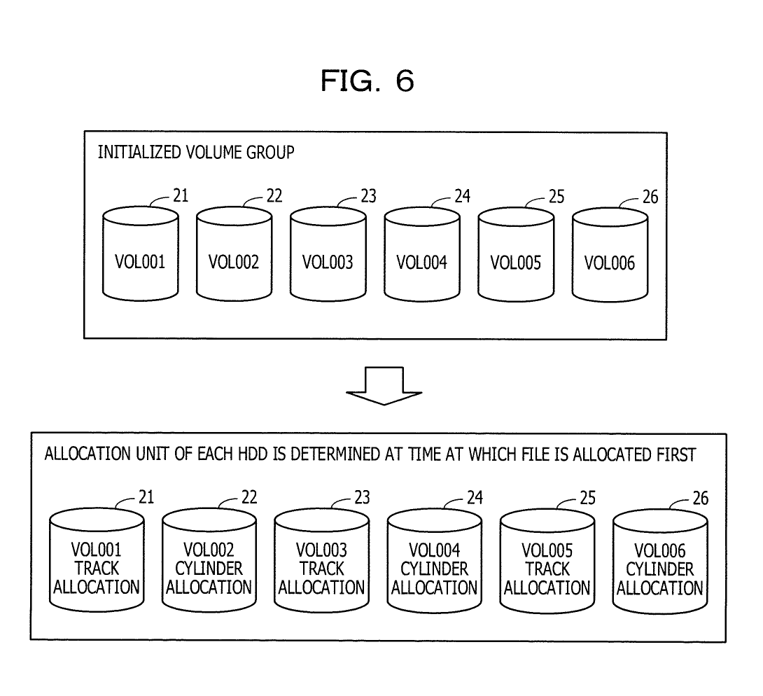

FIG. 6 is a diagram illustrating a classification example of the track allocation and the cylinder allocation. For example, it is assumed that the HDDs 21, 22, 23, 24, 25, and 26 are volumes (referred to as initialized volume) immediately after initialization at a certain time. In this case, a set of the HDDs 21, 22, 23, 24, 25, and 26 is an initialized volume group. Classification of the allocation unit of the HDD included in the initialized volume group is not determined.

Here, the identification information of the HDD is called as a volume ID. The volume ID of the HDD 21 is “VOL001”. The volume ID of the HDD 22 is “VOL002”. The volume ID of the HDD 23 is “VOL003”. The volume ID of the HDD 24 is “VOL004”. The volume ID of the HDD 25 is “VOL005”. The volume ID of the HDD 26 is “VOL006”.

The access controller 130 determines the allocation unit of each HDD at a time at which the file is allocated first according to the unspecified allocation request input by a user. For example, in a case where the track allocation file is allocated first in the HDD 21, the access controller 130 determines the storage area allocation unit of the HDD 21 on the track.

In a case where the cylinder allocation file is allocated first in the HDD 22, the access controller 130 determines the storage area allocation unit of the HDD 22 on the cylinder. In a case where the track allocation file is allocated first in the HDD 23, the access controller 130 determines the storage area allocation unit of the HDD 23 on the track.

In a case where the cylinder allocation file is allocated first in the HDD 24, the access controller 130 determines the storage area allocation unit of the HDD 24 on the cylinder. In a case where the track allocation file is allocated first in the HDD 25, the access controller 130 determines the storage area allocation unit of the HDD 25 on the track.

In a case where the cylinder allocation file is allocated first in the HDD 26, the access controller 130 determines the storage area allocation unit of the HDD 26 on the cylinder. The access controller 130 registers the determined result of a classification destination of the allocation unit in the management information stored in the storage 110. Hereinafter, the HDD of which the allocation unit is classified as the cylinder may be called as a volume of the cylinder allocation. In addition, the HDD of which the allocation unit is classified as the track may be called as a volume of the track allocation.

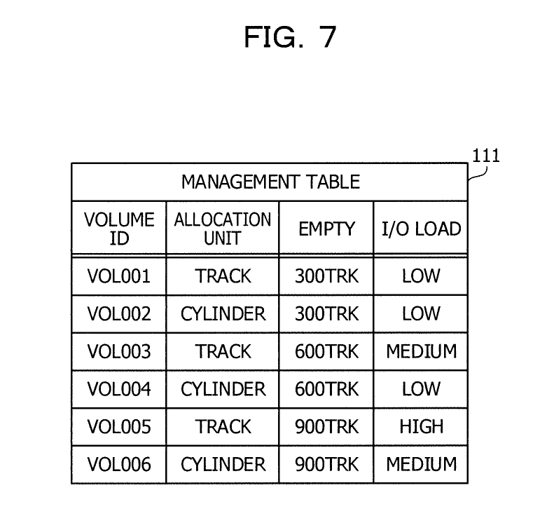

FIG. 7 is a diagram illustrating an example of a management table. The management table 111 is an example of the management information for managing the allocation unit, the unused space (empty amount), and the I/O load of each HDD. The management table 111 is stored in the storage 110. The management table 111 includes items of the volume ID, the allocation unit, an empty, and the I/O load.

The volume ID is registered in the item of the volume ID. Information indicating the allocation unit of the HDD corresponding to the volume ID is registered in the item of the allocation unit. In a case where the allocation unit is not determined, information indicating “undetermined” is registered in the item of the allocation unit. Information indicating an unused space amount of the HDD corresponding to the volume ID is registered in the item of the empty. For example, the unused space is indicated by the number (track number) of unused tracks. Information indicating the I/O load of the HDD corresponding to the volume ID is registered in the item of the I/O load. For example, the I/O load may be the number of I/Os per unit time. The I/O load is represented by multiple states depending on the load. In this example, the I/O load is expressed in three states of “low”, “medium”, and “high”. The “low” is a state with the lowest I/O load of the three stages. The “medium” is a state with the second highest I/O load of the three stages. The “high” is a state with the highest I/O load of the three stages.

For example, information that the volume ID is “VOL001”, the allocation unit is “track”, the empty is “300TRK” (TRK is approximately of TRacK), and the I/O load is “low”, is registered in the management table 111. This indicates that the allocation unit of the HDD 21 corresponding to the volume ID “VOL001” is the track, the amount of the unused space (empty space amount) is 300 tracks, and the I/O load is a low state.

Also, for other HDDs, information of the allocation unit, the empty (empty space), and the I/O load is registered in the management table 111. Under a predetermined condition, the access controller 130 may allocate the track allocation file to the HDD of which the allocation unit is the cylinder, and may allocate the cylinder allocation file to the HDD of which the allocation unit is the track. That is, the access controller 130 may temporally allow the mixing of the cylinder allocation file and the track allocation file for one HDD. Therefore, information of the “mixing” may be registered in the item of the allocation unit in addition to the “cylinder” and the “track”.

In addition, information relating to various empty spaces in each disk device such as the maximum consecutive empty space amount may be registered in the management table 111. Next, a specific process procedure by the mainframe 100 will be described.

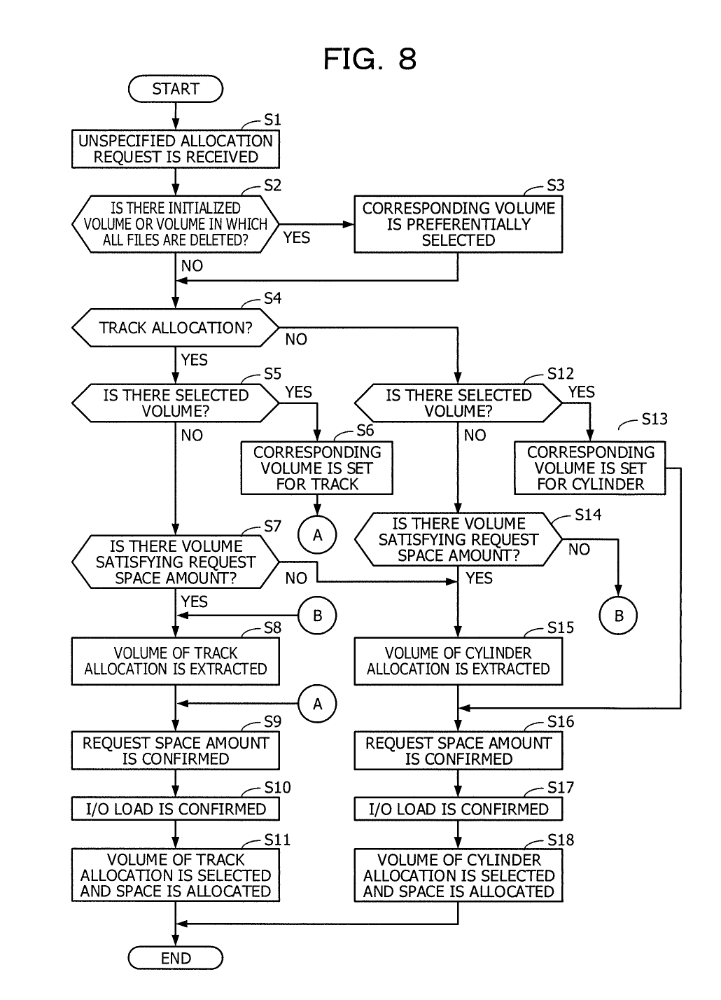

FIG. 8 is a flowchart illustrating an example in space allocation. Hereinafter, a process illustrated in FIG. 8 will be described along the step numbers. (S1) The access controller 130 receives the unspecified allocation request input by the user. For example, the user operates a terminal device connected to the network 10 such that it is possible to input the unspecified allocation request to the mainframe 100.

(S2) The access controller 130 determines whether or not there is the initialized volume or a volume in which the all files are deleted. In a case where there is the initialized volume or the volume in which the all files are deleted, the access controller 130 proceeds the process to step S3. In a case where there is no the initialized volume or the volume in which the all files are deleted, the access controller 130 proceeds the process to step S4. Here, the access controller 130 determines that the HDD in which the allocation unit in the management table 111 stored in the storage 110 is set to be “undetermined” is the initialized volume or the volume in which the all files are deleted.

(S3) The access controller 130 preferentially selects a corresponding volume (HDD). Specifically, the access controller 130 selects the HDD determined to be the initialized volume or the volume in which the all files are deleted in step S2 as the allocation destination with priority over the other HDDs (HDD of which allocation unit is determined). In a case where there are a plurality of selection candidate HDDs, the access controller 130 may select the HDD in ascending order of the volume ID, or may select the HDD of the allocation destination according to another standard corresponding to a size of a storage capacity of each candidate HDD or the like.

(S4) The access controller 130 determines whether or not the unspecified allocation request is a request of the track allocation. In a case where it is the request of the track allocation, the access controller 130 proceeds the process to step S5. In a case where it is not the request of the track allocation (that is, in a case where it is request of cylinder allocation), the access controller 130 proceeds the process to step S12. As described above, the unspecified allocation request includes the designation of the cylinder or the track for the allocation unit. Therefore, the unspecified allocation request in which the allocation unit is designated to the track is the request of the track allocation. Meanwhile, the unspecified allocation request in which the allocation unit is designated to the cylinder is the request of the cylinder allocation.

(S5) The access controller 130 determines whether or not there is a volume (selected volume) selected in step S3. In a case where there is the selected volume, the access controller 130 proceeds the process to step S6. In a case where there is no the selected volume, the access controller 130 proceeds the process to step S7.

(S6) The access controller 130 sets the selected volume for the track. Specifically, the access controller 130 classifies the allocation unit of the HDD corresponding to the selected volume into the track. More specifically, the access controller 130 registers the “track” of the allocation unit for the volume ID of a corresponding HDD in the management table 111. Then, the access controller 130 proceeds the process to step S9.

(S7) The access controller 130 determines whether or not there is a volume (HDD) satisfying the requested space amount designated by the unspecified allocation request in the volume of the track allocation. In a case where there is the volume satisfying the requested space amount in the volume of the track allocation, the access controller 130 proceeds the process to step S8. In a case where there is no the volume satisfying the requested space amount in the volume of the track allocation, the access controller 130 proceeds the process to step S15. Here, in the unspecified allocation request, the requested space amount is designated by the number of tracks. The access controller 130 refers to the management table 111, and specifies that the HDD corresponding to the volume ID of which the allocation unit is the “track” is the track allocation volume. Then, the access controller 130 compares the number of tracks in the item of the empty corresponding to a corresponding volume ID with the number of tracks designated as the requested space amount, and searches for the volume of the track allocation having the number of empty tracks equal to or larger than the requested space amount. As a searched result, when there is the volume of the track allocation having the number of empty tracks equal to or larger than the requested space amount, the access controller 130 determines that there is a volume satisfying the requested space amount. Meanwhile, as the searched result, when there is no the volume of the track allocation having the number of empty tracks equal to or larger than the requested space amount, the access controller 130 determines that there is no the volume satisfying the requested space amount.

(S8) The access controller 130 extracts the track allocation volume. Specifically, the access controller 130 refers to the management table 111, and extracts the volume ID of which the allocation unit is the “track”.

(S9) The access controller 130 performs confirmation of the requested space amount. The access controller 130 specifies the volume ID with the empty equal to or greater than the requested space amount among the volume IDs extracted in step S8. In a case where there is the volume selected in step S3, it is considered that the empty of the selected volume is equal to or greater than the requested space amount (since it is a state in which no file is allocated).

(S10) The access controller 130 performs confirmation of the I/O load. The access controller 130 specifies the volume ID with the lowest I/O load among the volume IDs specified in step S9. In a case where there is the volume selected in step S3, it is considered that the I/O load of the selected volume is the smallest among the track allocation volumes (since it is a state in which no file is allocated).

(S11) The access controller 130 selects the volume of the track allocation (HDD) corresponding to the volume ID specified in step S10, and allocates the space of the selected volume for a file designated in the unspecified allocation request. In a case where there is a volume selected in step S3, the current allocation destination is the selected volume. In a case where step S11 is performed via No in step S14, the access controller 130 sets the allocation unit of the selected volume as the “mixing” in the management table 111. Then, the access controller 130 ends the process.

(S12) The access controller 130 determines whether or not there is the volume selected in step S3. In a case where there is the selected volume, the access controller 130 proceeds the process to step S13. In a case where there is no the selected volume, the access controller 130 proceeds the process to step S14.

(S13) The access controller 130 sets the selected volume for the cylinder. Specifically, the access controller 130 classifies the allocation unit of the HDD corresponding to the selected volume into the cylinder. More specifically, the access controller 130 registers the “cylinder” of the allocation unit in the management table 111 for the volume ID of a corresponding HDD. Then, the access controller 130 proceeds the process to step S16.

(S14) The access controller 130 determines whether or not there is a volume (HDD) satisfying the requested space amount designated in the unspecified allocation request in the volume of the cylinder allocation. In a case where there is the volume satisfying the requested space amount among the volumes of the cylinder allocation, the access controller 130 proceeds the process to step S15. In a case where there is no the volume satisfying the requested space amount among the volumes of the cylinder allocation, the access controller 130 proceeds the process to step S8. Here, in the unspecified allocation request, the requested space amount is designated by the number of tracks. The access controller 130 refers to the management table 111, and specifies that the HDD corresponding to the volume ID of which the allocation unit is the “cylinder” is the volume of the cylinder allocation. Then, the access controller 130 compares the number of tracks in the item of the empty corresponding to the volume ID with the number of tracks designated as the requested space amount, and searches for the volume of the cylinder allocation having the number of empty tracks equal to or greater than the requested space amount. As the searched result, when there is the volume of the cylinder allocation having the number of the empty tracks equal to or greater than the requested space amount, the access controller 130 determines that there is a volume satisfying the requested space amount. Meanwhile, as the searched result, when there is no the volume of the cylinder allocation having the number of the empty tracks the number of tracks equal to or greater than the requested space amount, the access controller 130 determines that there is no volume satisfying the requested space amount.

(S15) The access controller 130 extracts the volume of the cylinder allocation. Specifically, the access controller 130 refers to the management table 111, and extracts the volume ID of which the allocation unit is the “cylinder”.

(S16) The access controller 130 performs confirmation of the requested space amount. The access controller 130 specifies the volume ID with the empty equal to or greater than the requested space amount among the volume IDs extracted in step S15. In a case where there is the volume selected in step S3, it is considered that the empty of the selected volume is equal to or greater than the requested space amount (since it is a state in which no file is allocated).

(S17) The access controller 130 performs confirmation of the I/O load. The access controller 130 specifies the volume ID with the lowest I/O load among the volume IDs specified in step S16. In a case where there is the volume selected in step S3, it is considered that the I/O load of the selected volume is the lowest in the volume of the track allocation (since it is a state in which no file is allocated).

(S18) The access controller 130 selects the volume of the cylinder allocation (HDD) corresponding to the volume ID specified in step S17, and allocates a space of the selected volume for a file designated in the unspecified allocation request. In a case where there is the volume selected in step S3, the current allocation destination is the selected volume. In a case where step S18 is performed via No in step S7, the access controller 130 sets the allocation unit of the selected volume in the “mixing” in the management table 111. Then, the access controller 130 ends the process.

According to a procedure of FIG. 8, the access controller 130 selects a HDD (volume) of the allocation destination according to the unspecified allocation request according to the following three references R1, R2, and R3 based on the management table 111. The criterion R1 indicates a match between the allocation unit designated by the unspecified allocation request and the allocation unit with which the HDD is classified. The criterion R2 indicates that the unused space amount of the HDD satisfies the requested space amount designated in the unspecified allocation request. The criterion R3 indicates that the I/O load is small.

However, in a case where the HDD of the allocation destination is not determined according to the references R1 and R2, the access controller 130 exceptionally allows the HDD classified with a different allocation unit to be a candidate of the allocation destination.

In addition, when No in step S7 or No in step S14, in a case where the allocation unit is the volume (HDD) of the “mixing”, the access controller 130 may preferentially select the volume of which the allocation unit is the “mixing” as the current allocation destination. This is to suppress the occurrence of a new volume of which the allocation unit is the “mixing”.

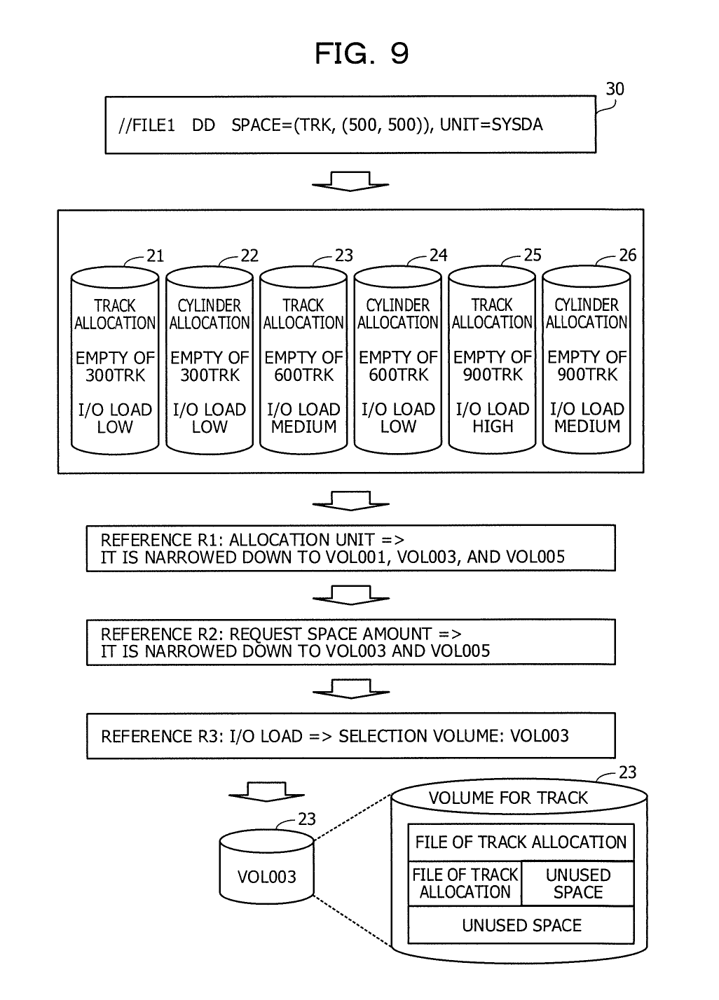

FIG. 9 is a diagram illustrating a first specification example of the space allocation. In FIG. 9, an example of allocating the unused space for a file indicated in “FILE1” by an unspecified allocation request 30 described by a JCL data definition (DD) statement is illustrated. The track is designated in the unspecified allocation request 30 as the allocation unit (first argument “TRK” of SPACE parameter). In addition, in the unspecified allocation request 30, as the requested space amount, 500TRK (space of the number of tracks 500) is designated (primary capacity of second argument “(m, n)” of SPACE parameter=“500”TRK). In the SPACE parameter, it is also possible to designate a secondary capacity n in a case where the primary capacity m may not be secured by a single volume (designation for securing space of the number of tracks n in allocation unit designated from different volume).

Furthermore, “SYSDA” as a UNIT name is designated in the unspecified allocation request 30. The UNIT is a parameter for designating a device name of the allocation destination. The UNIT name “SYSDA” is a name (predetermined name) corresponding to the entire HDD (HDD included in storage device 20) used for storing the file for business by the mainframe 100. That is, designation (designation of individual HDD) of a specific HDD is not included in the unspecified allocation request 30, as the allocation destination. This is why it is called as request of the “unspecified” allocation. Here, the UNIT name “SYSDA” indicates a set of the HDDs 21, 22, 23, 24, 25, and 26.

In addition, at a timing at which the access controller 130 receives the unspecified allocation request 30, the management table 111 stored in the storage 110 indicates the following state for each HDD. In the HDD 21, the allocation unit is the “track”, the empty is “300TRK”, and the I/O load is the “low”. In the HDD 22, the allocation unit is the “cylinder”, the empty is “300TRK”, and the I/O load is the “low”. In the HDD 23, the allocation unit is the “track”, the empty is “600TRK”, and the I/O load is the “medium”. In the HDD 24, the allocation unit is the “cylinder”, the empty is “600TRK”, and the I/O load is the “low”. In the HDD 25, the allocation unit is the “track”, the empty is “900TRK”, and the I/O load is the “high”. In the HDD 26, the allocation unit is the “cylinder”, the empty is “900TRK”, and the I/O load is the “medium”.

The access controller 130 refers to the management table 111, and narrows down selection candidates to the volume IDs “VOL001”, “VOL003”, and “VOL005” of which the allocation unit is the track, for the “track” of the allocation unit designated in the unspecified allocation request 30 (narrowing of criterion R1).

Next, the access controller 130 refers to the management table, and narrows down the narrowed result of the criterion R1 to the volume IDs “VOL003” and “VOL005” of which the unused space amount is equal to or greater than “500TRK”, for the requested space amount “500” designated in the unspecified allocation request 30 (narrowing of criterion R2).

Furthermore, the access controller 130 refers to the management table, and narrows down the narrowed result of the criterion R2 to the volume ID “VOL003” of which the I/O load is the lowest (narrowing of criterion R3).

Then, the access controller 130 determines the HDD 23 corresponding to the finally narrowed down volume ID “VOL003” as the allocation destination. The HDD 23 is the volume of the track allocation (volume for track). The access controller 130 allocates the storage area of the HDD 23 for the file. The access controller 130 writes the file in the allocated storage area of the HDD 23.

Even in a case where the cylinder is designated in the unspecified allocation request as the allocation unit, the access controller 130 narrows down the HDDs 22, 24, and 26 of which the allocation unit is classified as the cylinder, and furthermore, the allocation destination is determined according to the requested space amount and the confirmation of the I/O load.

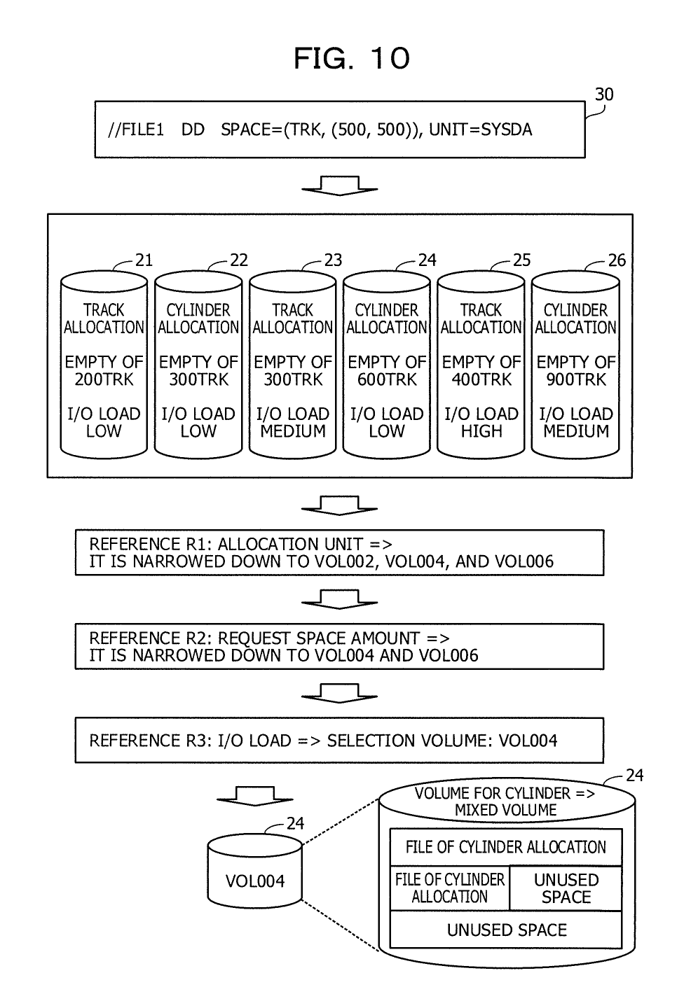

FIG. 10 is a diagram illustrating a second specification example of the space allocation. In FIG. 10, similar to a case of FIG. 9, an example in which the unused space is allocated for the file indicated by “FILE1” by the unspecified allocation request 30 described in a JCL DD statement, is illustrated. In the following description, a setting item is the same as that of the management table 111 exemplified in FIG. 7. However, in a case where a case relating to the management table having different setting values is described, the case is written with the “management table”, and no sign is given.

At a timing at which the access controller 130 receives the unspecified allocation request 30, the management table stored in the storage 110 indicates the following state for each HDD. In the HDD 21, the allocation unit is the “track”, the empty is “200TRK”, and the I/O load is the “low”. In the HDD 22, the allocation unit is the “cylinder”, the empty is “300TRK”, and the I/O load is the “low”. In the HDD 23, the allocation unit is the “track”, the empty is “300TRK”, and the I/O load is the “medium”. In the HDD 24, the allocation unit is the “cylinder”, the empty is “600TRK”, and the I/O load is the “low”. In the HDD 25, the allocation unit is the “track”, the empty is “400TRK”, and the I/O load is the “high”. In the HDD 26, the allocation unit is the “cylinder”, the empty is “900TRK”, and the I/O load is the “medium”.

The access controller 130 refers to the management table, and confirms the unused space amount of the volume IDs “VOL001”, “VOL003”, and “VOL005” of which the allocation unit is the track, for the “track” of the allocation unit designated in the unspecified allocation request 30. In this case, the unused space amount of the volume IDs “VOL001”, “VOL003”, and “VOL005” is less than “500TRK” which is the requested space amount of the unspecified allocation request 30, and in either case, the unused space is insufficient. Therefore, the access controller 130 refers to the management table, and narrows down the selection candidate to the volume IDs “VOL002”, “VOL004”, and “VOL006” of which the allocation unit is the cylinder. The narrowing down is also referred to as narrowing down by the criterion R1 for the sake of convenience.

Next, the access controller 130 refers to the management table, the narrowed result of the criterion R1, and narrows down the volume IDs “VOL004” and “VOL006” of which the unused space amount is equal to or greater than “500TRK”, for the requested space amount “500” designated in the unspecified allocation request 30 (narrowing of criterion R2).

Furthermore, the access controller 130 refers to the management table, and narrows down the narrowed result of the criterion R2 to the volume ID “VOL004” of which the I/O load is the lowest (narrowing of criterion R3).

Then, the access controller 130 determines the HDD 24 corresponding to the finally narrowed down volume ID “VOL004” as the allocation destination. The HDD 24 is the volume of the track allocation (volume for cylinder). However, by the current allocation, the track allocation file and the cylinder allocation file are mixed with each other on the HDD 24. As described above, the HDD in which the track allocation file and the cylinder allocation file are mixed with each other is called as a mixed volume. The access controller 130 updates the allocation unit of HDD 24 (volume ID “VOL004”) in the management table to the “mixing”.

The access controller 130 allocates the storage area of the HDD 24 for the file. The access controller 130 writes the file in the allocated storage area of the HDD 24. However, in this case, the start of the unused space can be a non-cylinder boundary. For example, in an example of FIG. 10, not all of the predetermined cylinders in the HDD 24 but only a part of the cylinder is allocated to the track allocation file.

The access controller 130 may not be able to secure the requested space amount from the HDD of which the allocation unit is classified as the cylinder, for the unspecified allocation request in which the cylinder is designated as the allocation unit. In this case, the access controller 130 may allocate the storage area of the HDD of which the allocation unit is classified as the track, for the unspecified allocation request.

As described above, even when the storage area of the allocation unit of the HDD designated in the unspecified allocation request 30 may not be secured, the access controller 130 can improve the utilization efficiency of the HDD by using the HDD classified as another allocation unit as the allocation destination.

In order not to increase the mixed volume, in a case where there is no the HDD satisfying the requested space amount for the unspecified allocation request, the access controller 130 preferentially uses the mixed volume as the allocation destination next time.

That is, in a case where the empty amount of each HDD classified into the cylinder unit for a new cylinder allocation file is insufficient, the access controller 130 detects the HDD in which an existing cylinder allocation file and an existing track allocation file are mixed with each other. The access controller 130 allocates the new cylinder allocation file on the detected HDD in preference to other HDDs. Alternatively, in a case where the empty amount of each HDD classified into the track unit for a new track allocation file is insufficient, the access controller 130 similarly detects the HDD in which the existing cylinder allocation file and the existing track allocation file are mixed with each other. The access controller 130 allocates the new track allocation file on the detected HDD in preference to other HDDs.

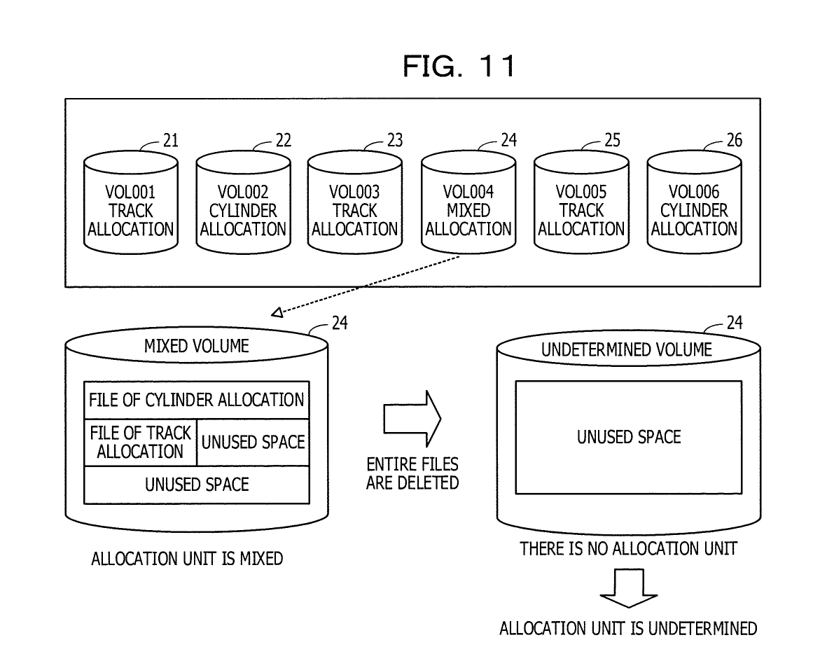

FIG. 11 is a diagram illustrating a change from the mixed volume to an undetermined volume. The volume manager 120 may change the allocation unit of the mixed volume to be “undetermined”. For example, it is assumed that the HDD 24 is the mixed volume in which the cylinder allocation file and the track allocation file are mixed with each other at a certain time.

Here, for the convenience of operation, the all files stored in the HDD 24 may be deleted. For example, the HDD 24 is initialized, or the all files stored in the HDD 24 are deleted by a predetermined command.

In a case where the all files are deleted for the HDD 24, the entire storage areas of the HDD 24 are the unused spaces. Therefore, when all files are deleted, the volume manager 120 resets the classification of the allocation unit for the HDD 24 for the HDD 24. Specifically, the volume manager 120 sets the allocation unit for the volume ID of the HDD 24 in the management table stored in the storage 110 to be “undetermined”. Thus, for the HDD 24 of which the allocation unit is not determined, whether or not the allocation unit is the cylinder or the track according to the request of the next and subsequent unspecified allocation is determined by the access controller 130.

Here, for the HDD of which the allocation unit is classified as the “cylinder” or the “track”, the volume manager 120 sets the allocation unit of the HDD in the management table to be “undetermined” at a timing at which the all files within the HDD are deleted.

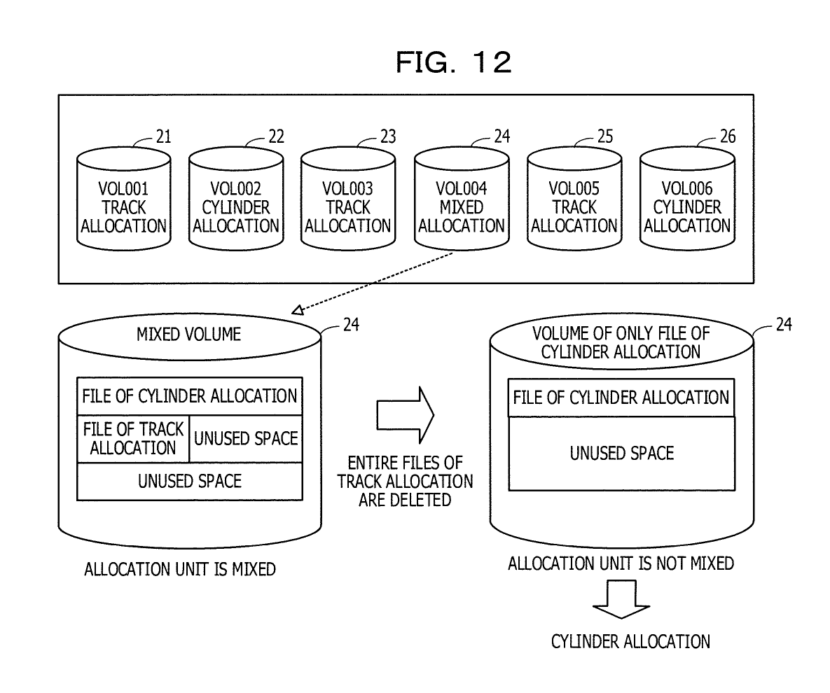

A process of setting the allocation unit of the HDD to be “undetermined” may be performed by the access controller 130 instead of the volume manager 120. FIG. 12 is a diagram illustrating a change from the mixed volume to the cylinder allocated volume. The volume manager 120 may change the allocation unit of the mixed volume to the “cylinder”. For example, at a certain time, it is assumed that the HDD 24 is the mixed volume in which the cylinder allocation file and the track allocation file are mixed with each other.

Here, the entire track allocation files may be deleted from the mixed volume. For example, the track allocation file may be collectively deleted from the mixed volume or the track allocation file is gradually deleted from the mixed volume and the entire track allocation files may be finally deleted. More specifically, in a case where the track allocation file in the mixed volume is a temporary file used for a predetermined business process, when the corresponding business process is completed once, the temporary file is also deleted. Particularly, since a file to be a target of the unspecified allocation request is often a temporary file, all of them is highly likely to be deleted.

When the entire track allocation files are deleted from the HDD 24 (mixed volume), the volume manager 120 sets the allocation unit for a corresponding HDD to the “cylinder” (because allocation unit becomes non-mixing). Specifically, the volume manager 120 sets the allocation unit for the volume ID of a corresponding HDD to the “cylinder” in the management table stored in the storage 110.

Here, the volume manager 120 confirms that the entire track allocation files are deleted from the HDD 24 which is the mixed volume based on, for example, a log of the unspecified allocation request. For example, the log is stored in the storage 110 by the access controller 130. It is considered that the access controller 130 may record the content (designated allocation unit) of the unspecified allocation request and the volume ID of the HDD that is actually allocated, in association with an identification name of a file in the log. The access controller 130 also records a deletion operation of a file in the log. For example, the access controller 130 records the identification name of the deleted file in the log. In this manner, the volume manager 120 can detect that the entire track allocation files are deleted from the HDD 24 that is the mixed volume based on the log. For example, in order to change the allocation unit, the volume manager 120 may confirm the log every time the file is deleted or may confirm the log at a predetermined cycle.

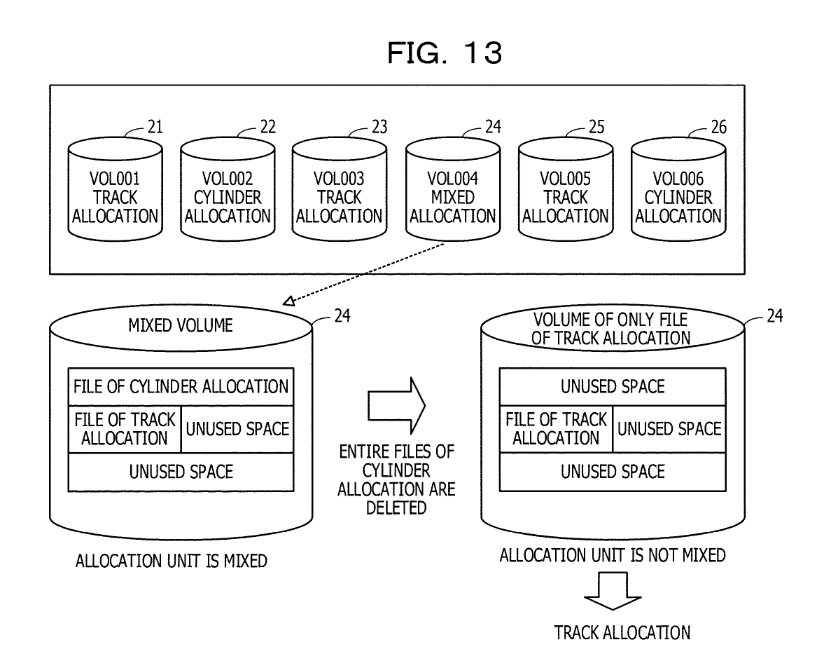

A process of changing the allocation unit of the HDD from the “mixing” to the “cylinder” may be performed by the access controller 130, instead of the volume manager 120. FIG. 13 is a diagram illustrating a change from the mixed volume to the track allocation volume. The volume manager 120 may change the allocation unit of the mixed volume to the “track”. For example, at a certain time, it is assumed that the HDD 24 is the mixed volume in which the cylinder allocation file and the track allocation file are mixed with each other.

Here, the entire cylinder allocation files may be deleted from the mixed volume. For example, the cylinder allocation file may be collectively deleted from the mixed volume or the cylinder allocation file is gradually deleted from the mixed volume and the entire cylinder allocation files may be finally deleted. More specifically, in a case where the cylinder allocation file in the mixed volume is a temporary file used for a predetermined business process, when the corresponding business process is completed once, the temporary file is also deleted. As described above, since a file to be a target of the unspecified allocation request is often a temporary file, all of them is highly likely to be deleted.

When the entire cylinder allocation files are deleted from the HDD 24 (mixed volume), the volume manager 120 sets the allocation unit for a corresponding HDD to the “track” (because allocation unit becomes non-mixing). Specifically, the volume manager 120 sets the allocation unit for the volume ID of a corresponding HDD to the “track” in the management table stored in the storage 110.

Here, the volume manager 120 detects that the entire cylinder allocation files are deleted from the HDD 24 that is the mixed volume, by the above-described log recorded by, for example, the access controller 130. For example, in order to change the allocation unit, the volume manager 120 may confirm the log every time the file is deleted or may confirm the log at a predetermined cycle.

A process of changing the allocation unit of the HDD from the “mixing” to the “track” may be performed by the access controller 130, instead of the volume manager 120. As described above, the mainframe 100 classifies the allocation unit of each HDD into one of the track allocation and the cylinder allocation. Then, the mainframe 100 sets the HDD included in a classification matching the allocation unit designated in the unspecified allocation request as the allocation destination. With this, the cylinder allocation file is allocated in the HDD of which the allocation unit is the cylinder, and the track allocation file is allocated in the HDD of which the allocation unit is the track (however, there is exception). Therefore, focusing on one HDD, the fragmentation of the unused space in the HDD can be suppressed, and it is easy to secure a consecutive unused space.

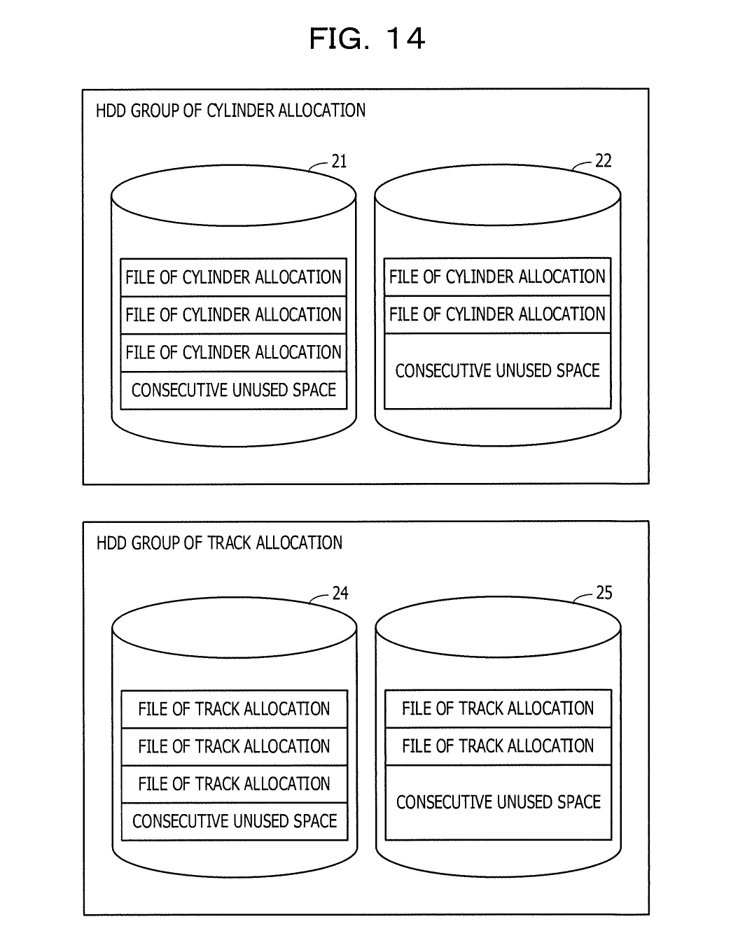

FIG. 14 is a diagram illustrating an example of the consecutive unused space. In FIG. 14, the HDDs 21 and 22 of the cylinder allocation (allocation unit is cylinder) and HDDs 24 and 25 of the track allocation (allocation unit is track) are illustrated (HDDs 23 and 26 are omitted).

In examples of the HDDs 21 and 22, a file allocated in each of the HDDs 21 and 22 is mainly the cylinder allocation file. Therefore, in the HDDs 21 and 22, the fragmentation of the unused space exemplified in FIG. 4 hardly occurs. This is because, when focusing on one cylinder, a possibility that only a part of the storage area of the cylinder is allocated to a specific file, decreases, and a possibility that the storage area allocation is performed from the cylinder boundary for the cylinder allocation file, increases.

In addition, in examples of the HDDs 24 and 25, a file allocated in each of the HDDs 24 and 25 is mainly the track allocation file. Therefore, in the HDDs 24 and 25, the fragmentation of the unused space exemplified in FIG. 4 hardly occurs. The reason is as follows. Even when only a part of the storage area of the cylinder is allocated to a certain file when focusing on one cylinder, there is a high possibility that the file allocated to the HDDs 24 and 25 is the track allocation file. In a case where it is the track allocation file, since there is no limitation of setting the storage area from the cylinder boundary, there is a high possibility that the remaining unused space of the cylinder is allocated, and there is a low possibility that the unused space is fragmented.

As described above, according to the mainframe 100, in the same HDD, it is possible to reduce the mixing of the cylinder allocation file and the track allocation file. As a result, it is possible to suppress the fragmentation of the unused space. By suppressing the fragmentation of the unused space, there is a high possibility that the consecutive unused space can be secured for the requested space amount. In this manner, it is possible to suppress the unused space being shredded and remaining unused, and it is possible to efficiently use the storage area of each HDD.

In addition, since the fragmentation can be reduced without correcting JCL, it is also possible to reduce abnormal termination of an unspecified allocation job due to the lack of space. Furthermore, even when the user does not predefine a volume group, the allocation unit is classified on the side of the mainframe 100, so that there is an advantage that labor saving of the user's work accompanying operation can be saved. In addition, in the JCL, the unspecified allocation request may be input, and there is also an advantage that the user is not forced to input with consciousness of the allocation unit and labor saving of the user's work accompanying operation can be saved. As described above, according to the mainframe 100, it is possible to select an appropriate allocation destination volume (HDD) that can suppress the fragmentation without correcting the JCL.

An information process of a first embodiment can be realized by executing a program in the processor lb. In addition, an information process of a second embodiment can be realized by executing a program in the processor 101. The program can be recorded on a computer-readable recording medium 13.

For example, by distributing the recording medium 13 in which a program is recorded, the program can be distributed. In addition, when the program is stored in other computers, the program may be distributed through a network. For example, the program stored in the recording medium 13 or the program received from other computers may be stored (installed) in a storage device such as the RAM 102 and the HDD 103, and may be executed by reading the program the storage device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and the processor configured to execute a process, the process including:
receiving a first allocation request to allocate first data to any one of a plurality of disk storage devices, the first allocation request including a designation of an allocation unit for the first data, the allocation unit for the first data being a cylinder unit or a track unit;
allocating the first data to a first disk storage device in the plurality of disk storage devices;
receiving a second allocation request to allocate second data to any one of the plurality of disk storage devices, the second allocation request including a designation of an allocation unit for the second data, the allocation unit for the second data being the cylinder unit or the track unit; and
allocating the second data to the first disk storage device when the designation of the allocation unit for the second data is same as the designation of the allocation unit for the first data and allocating the second data to a second disk storage device in the plurality of disk storage devices when the allocation unit for the second data is different from the allocation unit for the first data.

2. The information processing apparatus according to claim 1, wherein
the process further comprises:
allocating the first data to any one of the plurality of disk storage devices other than the first disk storage device when an empty data amount of the first disk storage device is insufficient; and
allocating the second data to any one of the plurality of disk storage devices other than the second disk storage device when an empty data amount of the second disk storage device is insufficient.

3. The information processing apparatus according to claim 1, wherein
the process further comprises:
allocating the first data to the second disk storage device when an empty data amount of the first disk storage device is insufficient; and
allocating the second data to the first disk storage device when an empty data amount of the second disk storage device is insufficient.

4. The information processing apparatus according to claim 1, wherein
the plurality of disk storage devices includes a third disk storage device that mixedly stores data for which an allocation unit is the cylinder unit and data for which an allocation unit is the track unit; and wherein
the process further comprises:
allocating the first data to the third disk storage device when an empty data amount of the first disk storage device is insufficient; and
allocating the second data to the third disk storage device when an empty data amount of the second disk storage device is insufficient.

5. The information processing apparatus according to claim 1, wherein
the memory stores setting information that indicates each of allocation units set for each of the plurality of disk storage devices; wherein
each of the allocation units for each of the plurality of disk storage devices are set based on an allocation unit for data firstly allocated to each of the plurality of disk storage devices.

6. The information processing apparatus according to claim 5, wherein the process further comprises:
setting an allocation unit of one of the plurality of disk storage devices to be undetermined when all data in the one of the plurality of disk storage devices is deleted.

7. A non-transitory computer-readable storage medium storing a program that causes a computer to execute a process, the process comprising:
receiving a first allocation request to allocate first data to any one of a plurality of disk storage devices, the first allocation request including a designation of an allocation unit for the first data, the allocation unit for the first data being a cylinder unit or a track unit;
allocating the first data to a first disk storage device in the plurality of disk storage devices;
receiving a second allocation request to allocate second data to any one of the plurality of disk storage devices, the second allocation request including a designation of an allocation unit for the second data, the allocation unit for the second data being the cylinder unit or the track unit; and
allocating the second data to the first disk storage device when the designation of the allocation unit for the second data is same as the designation of the allocation unit for the first data and allocating the second data to a second disk storage device in the plurality of disk storage devices when the allocation unit for the second data is different from the allocation unit for the first data.

8. An information processing method executed by a computer, the information processing method comprising:
receiving a first allocation request to allocate first data to any one of a plurality of disk storage devices, the first allocation request including a designation of an allocation unit for the first data, the allocation unit for the first data being a cylinder unit or a track unit;
allocating the first data to a first disk storage device in the plurality of disk storage devices;
receiving a second allocation request to allocate second data to any one of the plurality of disk storage devices, the second allocation request including a designation of an allocation unit for the second data, the allocation unit for the second data being the cylinder unit or the track unit; and
allocating the second data to the first disk storage device when the designation of the allocation unit for the second data is same as the designation of the allocation unit for the first data and allocating the second data to a second disk storage device in the plurality of disk storage devices when the allocation unit for the second data is different from the allocation unit for the first data.
